(19) United States
(12) Patent Application Publication
(10) Pub. No.: US 2025/0035165 A1
(43) Pub. Date: Jan. 30, 2025

(54) SENSOR BEARING ASSEMBLY

(71) Applicant: AKTIEBOLAGET SKF, GOTEBORG (SE)

(72) Inventor: Manoj BABU M, Hosur (IN)

(21) Appl. No.: 18/360,207

(22) Filed: Jul. 27, 2023

(30) Foreign Application Priority Data
Aug. 5, 2022 (IN) 202241044835

(51) Int. Cl. F16C 41/00

(52) U.S. Cl. CPC F16C 41/007; F16C 2233/00

(57) ABSTRACT

A sensor bearing assembly includes a bearing having inner and outer rings centered on an axis, an impulse ring secured to the bearing outer ring, the outer diameter of the impulse ring being less than or equal to the outer diameter of the bearing outer ring, a sensor device for detecting rotational parameters of the impulse ring including a sensor housing, a printed circuit board secured to the sensor housing, and at least two sensor elements supported by the printed circuit board and cooperating with the impulse ring. The at least two sensor elements each sense unique multiple points on the impulse ring and transmit an output signal having a unique set of points. An electronic unit receives the output signal of the multiple points from each of the sensor elements and merges the output signals into one final output signal.

### CROSS-REFERENCE

This application claims priority to Indian patent application No. 202241044835 filed on Aug. 5, 2022, the entire contents of which are fully incorporated herein by reference.

### BACKGROUND OF THE INVENTION

The present invention relates to bearings, and more particularly to sensor bearing assemblies.

It is known to fix an impulse ring of a sensing device on the outside of a wheel hub. However, such an impulse ring is typically subjected to external forces or impacts and therefore susceptible to damage. Furthermore, such an impulse ring increases the overall dimensions of the wheel hub.

In order to avoid damage from external forces or impact when a reduction of the overall dimensions of the hub is possible, it is known to integrate an impulse ring in a unit inside a wheel.

The present invention thus relates more particularly to a sensor bearing assembly including a bearing, an impulse ring, a sensor device and a spacer supporting the sensor device. Today, sensor bearing assemblies or units are commonly used in a wide range of technical fields, for example in automotive industry and aeronautics. These units provide high quality signals and transmissions, while allowing integration into a simpler and more compact apparatus. A sensor bearing unit generally includes a bearing, an impulse ring secured to the rotatable ring of the bearing and a sensor unit or device in order to sense points on the impulse ring.

WO-A1-2015/010737 discloses an example of a sensor bearing unit installed on a two-wheeled vehicle axle. The sensor bearing unit includes an impulse ring secured to the outer ring of the rolling bearing, a spacer mounted within the bore of the inner ring, and a sensor device including a sensor housing freely mounted on the spacer.

With such a solution, it is necessary to provide a specific shape on the axle of the two-wheeled vehicle intended to receive the sensor bearing unit. It is also necessary for the fork to function to rotationally lock the sensor device.

Incremental rotary encoders, known as quadrature encoders, are also known to measures the speed and direction of a rotating shaft. Such encoders generally use sensors each having an output in a square waveform of 90°. In order to monitor the rotational speed, only one output is used.

### BRIEF SUMMARY OF THE INVENTION

The invention relates to a sensor bearing assembly comprising a bearing including an inner ring and an outer ring centered on an axis, and an impulse ring secured to the outer ring of the bearing.

An aim of the present invention is to achieve the capability of sensing multiple positions of the bearing without increasing the “reading” or sensing diameter of the impulse wheel and thus without increasing the overall dimensions of the sensor bearing assembly.

According to a first general feature, the outer diameter of the impulse ring is less than or equal to the outer diameter of the outer ring of the bearing.

The sensor bearing assembly further comprises a sensor device for detecting rotational parameters of the impulse ring including a sensor housing, a printed circuit board secured to the sensor housing, and at least two sensor elements supported by the printed circuit board and cooperating with the impulse ring.

According to a second general feature, the sensor bearing assembly further comprises an annular spacer configured to axially abut against a lateral face of the inner ring of the bearing. The sensor housing of the sensor device is fixedly secured onto the spacer. The at least two sensor elements are each configured to sense unique multiple points on the impulse ring and to transmit an output signal having a unique set of points.

The sensor bearing assembly further comprises an electronic unit receiving the output signal of the multiple points from each of the two sensor elements and configured to merge the output signals into one final output signal.

With such a design, it is possible to achieve sensing of multiple positions of the bearing without increasing the reading diameter of the impulse wheel and thus without increasing the overall dimensions of the sensor bearing assembly. Furthermore, it is not necessary to provide a specific shape on the fork of the vehicle to angularly secure the sensor device. Also, the spacer does not protrude radially inwards relative to the inner ring of the bearing and the impulse ring does not protrude radially outwards relative to the outer ring. The radial boundary dimension of the sensor bearing assembly is identical to the radial boundary dimension of the bearings. Accordingly, it is not necessary to provide specific shapes on the axle and the hub of the vehicle.

Alternatively, a different number of sensor elements may be foreseen, for example more than two sensor elements, for example three sensor elements or at least four sensor elements. The sensor bearing assembly may be supplied as a kit comprising the spacer and the sensor device separate from the bearing. Alternatively, the sensor bearing assembly may comprise a single unit with the spacer secured to the inner ring of the bearing.

Preferably, the electronic unit comprises a digital logic gate exclusive OR, “XOR”, receiving the at least two waveforms output signals from the two sensor elements and transmitting a final output signal having the form of a wave with at least twice the frequency. In other words, the at least two outputs are processed through a high-speed logic circuit to obtain a number of pulses as a resultant of phase shift. As a non-limiting embodiment, the waveforms may have a square shape.

In one embodiment, the impulse ring comprises alternating North and South poles and the sensor elements comprises magnetic sensors. For example, the magnetic sensors may include a moving or a stationary magnet. Further for example, the sensors can be Hall-effect sensors, optic sensors, or inductive sensors, or any other type of sensors.

Preferably, the impulse ring includes a plurality of alternating solid parts or sections and through slots in the circumferential direction, each of the at least two sensor elements being configured to sense one unique point on each of the solid parts/sections.

Preferably, the number of pulses of each output signal transmitted from each sensor element is equal to the number of slots and the number of pulses of the final output signal is equal to the sum of the number of pulses of each output signal from the sensor elements.

For example, in an impulse ring having twenty-four slots, and in case of the sensor bearing including two sensor elements each configured to sense twenty-four unique points on the impulse ring, the number of pulses of each output signals transmitted from each sensor elements is equal to twenty-four and the number of pulses of the final output signal is equal to forty-eight.

As a comparison with the state of the art, the number of pulses of the final output signal from known devices is equal to the number of slots. Therefore, in order to increase the number of pulses of the final output signal, it is known to increase the number of slots, thereby increasing the reading diameter of the impulse ring. This drawback is avoided by the present invention.

Advantageously, one of the at least two sensor elements is configured to sense one unique point on each of the solid parts or sections of the impulse ring and the other of the at least two sensor elements is configured to sense another unique point on each one of the solid parts/sections of the impulse ring.

For example, one of the two sensors is configured to sense a point in the middle of each solid part or section of the impulse ring and the other of the two sensors is configured to sense a point on one of the edges of each solid part/section of the impulse ring, for example the trailing or the leading edge of the impulse ring. In another alternative, one of the two sensors is configured to sense the trailing edge of the impulse ring and the other of the two sensors is configured to sense the leading edge of the impulse ring.

In the case of using three sensors, all three of the middle part, the leading edge and the trailing edge of the impulse ring may be sensed.

In a non-limiting example, the two sensor elements are angularly spaced apart from each other at an angle enabling the generation of two 90° phase two shift pulses. The angle between the sensor elements is dependent on the type of waveform output signal ultimately needed.

For example, the two sensor elements may be angularly spaced apart from each other by an angle of 94°. As another example, the two sensor elements may be angularly spaced apart from each other by an angle of 120°.

In a non-limiting example, the inner diameter of the spacer is equal to the inner diameter of the inner ring of the bearing. Alternatively, the inner diameter of the spacer may be different than the inner diameter of the inner ring of the bearing.

Preferably, the impulse ring includes a radial portion facing a lateral face of the outer ring of the bearing and at least one opening extending through the thickness of the radial portion such that a part of the lateral face of the outer ring of the bearing is accessible from the outside through the opening. The through-opening of the impulse ring enables axially pushing directly on the lateral face of the outer ring of the bearing during the installation of the sensor bearing assembly. This leads to a simplified mounting of the sensor bearing assembly without deterioration of the impulse ring. Preferably, the opening of the impulse ring is radially located between the cylindrical bore and the cylindrical outer surface of the outer ring of the bearing. For example, the opening of the impulse ring may extend over an angular sector of between 0° to 180°.

In one embodiment, the impulse ring comprises a plurality of openings spaced apart in the circumferential direction. Preferably, the impulse ring includes a plurality of axial lugs spaced apart in the circumferential direction, one opening being circumferentially disposed between two successive axial lugs of the impulse ring. In one example, the axial lugs may extend over the same angular sector. As another example, each of the axial lugs may extend over a different angular sector. In this case, the angular sector of the openings will be different as well. In one embodiment, the outer surface of the outer ring of the bearing includes a shoulder axially delimiting a first and a second cylindrical portion of the outer surface, the axial lugs of the impulse ring being secured directly to the second cylindrical portion, without interposition of an additional element between the second cylindrical portion and the axial lugs of the impulse ring. If necessary, the bearing may be provided with seals each secured into a groove formed on the bore of the outer ring. The seals may be radially disposed between the inner and outer rings. In another embodiment the impulse ring may be secured to the outer ring of the bearing by rivets, or by dowel pins, or by gluing. Preferably, the sensor housing of the sensor device defines a space inside which are located the sensor elements.

In one embodiment, the sensor housing of the sensor device includes an annular inner axial portion fixedly secured onto the spacer, an annular outer axial portion radially surrounding the inner axial portion, and at least one annular radial portion extending between the inner and outer axial portions at a side opposite to the bearing, the sensor housing having an opening filled with a sealed portion, opposite to the annular radial portion and facing the bearing and the impulse ring. The sealed portion is, for example, a potting compound for resistance to shock and vibration, and for the exclusion of water, moisture, or corrosive agents. Accordingly, the sensor elements are protected thereby from external pollutants.

The sensor housing of the sensor device defines a space inside which is located the sensor element. The space is delimited by the inner and outer axial portions, the radial portion and the sealed portion (e.g., the potting compound).

In one embodiment, the impulse ring is made of metal and provided with alternating solid parts or teeth and through slots and the sensor element of the sensor device is configured to sense the metal impulse ring solid parts/sections and the through slots.

Preferably, the inner surface of the outer axial portion and the surface of the inner axial portion of the sensor housing has a stepped profile defining a shoulder, the printed circuit board being secured to the shoulder and axially faces the impulse ring and the bearing.

The assembly may further comprise at least one seal mounted on the outer surface of the sensor housing, the seal including an annular heel secured to the outer surface and at least one annular lip projecting outwardly from the heel. Such a seal increases the robustness of the assembly by eliminating the possibility of external pollutants reaching the impulse ring in the path of sensing. The lip of the seal may be in radial and/or in axial sealing contact with a bore of a wheel hub. For example, the seal may be mounted on the outer surface of the outer axial portion of the sensor housing. The seal may have an annular form. For example, the seal may be mounted in a groove provided on the outer surface of the outer portion of the sensor housing. The seal lip may extend obliquely on the side opposite to the bearing. The lip is flexible in the radial direction.

### BRIEF DESCRIPTION OF THE SEVERAL VIEWS OF THE DRAWINGS

The present invention and its advantages will be better understood by studying the detailed description of a specific embodiment given by way of non-limiting example and illustrated by the appended drawings on which:

FIG. 1 is an axial section view of a sensor bearing assembly according to a first example of the invention;

FIG. 2 is a perspective exploded view of the sensor bearing assembly of FIG. 1;

FIG. 3 is a perspective view of an impulse ring of the sensor bearing assembly of FIGS. 1 and 2;

FIG. 4 is a partial axial section view of a two-wheeled vehicle provided with the sensor bearing assembly of FIGS. 1 and 2; and

FIG. 5 is a signal flow diagram of the output signals of two sensor elements and the final output signal determined by the electronic unit of the sensor bearing assembly of FIGS. 1 and 2.

### DETAILED DESCRIPTION OF THE INVENTION

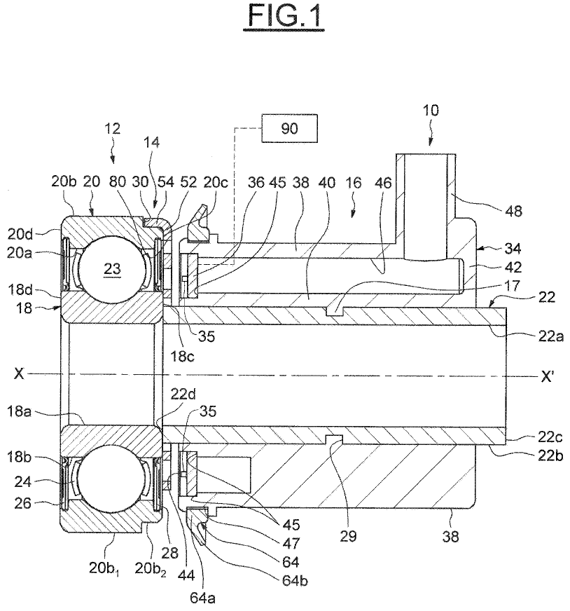

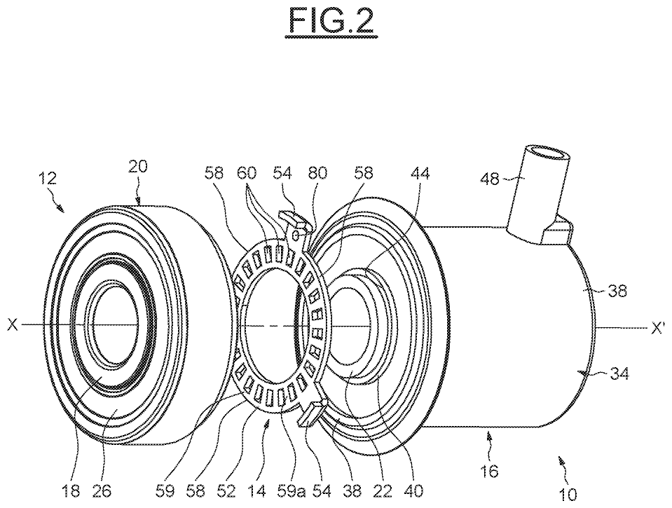

The sensor bearing assembly 10 depicted in FIG. 1 is particularly adapted to equip a vehicle such as a motorbike, a bicycle, a tricycle or a quad. As shown on FIGS. 1 and 2, the sensor bearing assembly 10 comprises a bearing 12, an impulse ring 14 and a sensor device 16 mounted on the bearing 12.

The bearing 12 includes an inner ring 18 and an outer ring 20. The inner and outer rings 18, 20 are concentric and extend axially along the bearing rotation axis X-X′ which runs in an axial direction. The outer ring 20 radially surrounds the inner ring 18. The inner and outer rings 18, 20 are preferably made of steel.

As will be described later, the sensor bearing assembly 10 further comprises a spacer 22 axially abutting against the inner ring 18 of the bearing 12. The impulse ring 14 is secured to the outer ring 20 of the bearing 12 and the sensor device 16 is secured on the spacer 22.

In the illustrated example, the bearing 12 also includes a row of rolling elements 23, which may be provided as balls as depicted, interposed between raceways (not referenced) formed on the inner and outer rings 18, 20.

The bearing 10 also includes a cage 24 configured to maintain a regular or even circumferential spacing of the rolling elements 23. The bearing 10 preferably further includes seals 26, 28 radially disposed between the inner and outer rings 18, 20 to define a space inside which the rolling elements 23 are arranged.

The outer ring 20 is provided with a cylindrical inner surface or bore 20a and with an outer cylindrical surface 20b which is radially opposite to the bore 20a. In the illustrated example, a toroidal circular raceway for the rolling elements 23 is formed from the bore 20a, the raceway being directed radially inwards. Two grooves (not referenced) are also formed on the bore 20a into which are secured the seals 26, 28.

In this example, the outer ring 20 is also provided with two opposite first and second radial lateral faces 20c, 20d which axially delimit the bore 20a and the outer surface 20b of the ring 20. A shoulder 30 is preferably formed on the outer surface 20b of the outer ring 20. The shoulder 30 extends radially inwards from the outer surface 20b of the outer ring 20. The shoulder 30 is formed on the side of the bearing 12 in the vicinity of the sensor device 16, axially opposite to the second radial lateral face 20d. Alternatively, the outer surface 20b of the outer ring 20 may be provided with a U-shaped groove.

In the illustrated example, the outer surface 20b of the outer ring 20 has a stepped shape. The outer surface 20b is provided with a first cylindrical portion 20b1 and with a second cylindrical portion 20b2 which is radially offset inwards, i.e., towards the inner ring 18, with respect to the first cylindrical portion 20b1. The diameter of the cylindrical portion 20b1 defines the outer diameter of the outer ring 20.

The shoulder 30 delimits axially the first and second cylindrical portions 20b1, 20b2. More precisely, the first cylindrical portion 20b1 is axially delimited by the second lateral face 20d and the shoulder 30 and the second cylindrical portion 20b2 is axially delimited by the first lateral face 20c and the groove 30.

Similarly, to the outer ring 20, the inner ring 18 is provided with a cylindrical inner surface or bore 18a and with an outer cylindrical surface 18b which is radially opposite to the bore 18a. In the illustrated example, a toroidal circular raceway for the rolling elements 23 is formed from the outer surface 18b, the raceway being directed radially outwards. The inner ring 18 is also provided with two opposite first and second radial lateral faces 18c, 18d which axially delimit the bore 18a and the outer surface 18b of the ring 18.

The spacer 22 has an annular form. The spacer 22 axially abuts against the first lateral face 18c of the inner ring 18. The spacer 22 does not protrude axially into the bore 18a of the inner ring 18. The spacer 22 is provided with a cylindrical inner surface or bore 22a and with an outer cylindrical surface 22b, which is radially opposite to the bore 22a.

In this example, and in a non-limiting way, the inner diameter of the spacer 22 is equal to the inner diameter of the inner ring 18 of the bearing 12. In other words, the diameter of the bore 22a of the spacer 22 is here equal to the diameter of the bore 18a of the inner ring 18. The spacer 22 is also provided with two opposite first and second radial lateral faces 22c, 22d which axially delimit the bore 22a and the outer surface 22b of the sleeve 22. The second lateral face 22d of the spacer axially comes into contact against the first lateral face 18c of the inner ring 18. The spacer 22 may be made of steel. As previously indicated, the sensor device 16 is secured on the spacer 22. More specifically, the sensor device 16 is preferably secured onto the outer surface 22b of the spacer 22.

The sensor device 16 includes a sensor body or housing 34 and two or more sensor elements 35 supported by the sensor housing 34. The sensor device 16 also comprises a printed circuit board 36 secured to the sensor housing 34 and supporting the sensor elements.

The sensor housing 34 preferably has an annular form. The sensor housing 34 is axially spaced apart from the bearing 12 and the impulse ring 14. The sensor housing 34 is fixedly secured onto the spacer 22. More specifically, the sensor housing 34 is preferably fixedly secured onto the outer surface 22b of the spacer 22. Preferably, the sensor housing 34 is incapable of sliding or rotating relative to the spacer 22.

In the example illustrated, the spacer 22 includes a groove 29 provided on the outer surface 22b of the spacer 22. The groove 29 is preferably annular. As an alternative, the groove 29 may comprise a plurality of grooves or notches and may be non-annular. The groove 29 is directed towards the bore 22a of the spacer 22.

The sensor device 16 is secured onto the spacer 22 due to the groove 30 cooperating with a rib 17 of complementary shape provided on the sensor device 16. As an alternative, the sensor device 16 may be press fit on the outer surface 22b of the spacer 22, without using any groove and rib. The sensor device 16 may also be glued on the outer surface 22b of the spacer 22. In this example, the outer diameter of the sensor housing 34 is smaller than the outer diameter of the outer ring 20 of the bearing 12.

The sensor housing 34 includes an annular outer axial portion 38, an annular inner axial portion 40 secured onto the spacer 22 and one annular radial portion 42 extending between the outer and inner axial portions 38, 40, at a side opposite to the bearing 12. As illustrated, the sensor housing 34 has a radial opening 44 facing the bearing 12 and the impulse ring 14. The radial opening 44 is filled with a sealing portion (not shown), such as for example, a potting compound. As an alternative, the sensor housing 34 may comprise two opposite annular radial portions. The outer and inner axial portions 38, 40 are concentric and coaxial with the axis X-X′. The inner axial portion 40 is fixedly secured onto the outer surface 22b of the spacer 22.

The outer surface of the outer axial portion 38 forms the outer surface of the sensor housing 34. The outer diameter of the outer axial portion 38 defines the outer diameter of the sensor housing 34. The outer diameter of the sensor housing 34 is preferably less than the outer diameter of the outer ring 20 of the bearing 12. Alternatively, the outer diameter of the sensor housing 34 may be equal to the outer diameter of the outer ring 20. The outer axial portion 38 of the sensor housing 34 radially surrounds the inner axial portion 40. The outer axial portion 38 extends axially between the radial portion 42 towards the bearing 12. The outer axial portion 38 extends axially a large-diameter edge of the radial portion 42. The inner axial portion 40 defines the bore of the sensor housing 34. The inner axial portion 40 is secured to the spacer 22. The inner axial portion 40 extends axially between the radial portion 42 and the opening 44. The inner axial portion 40 extends axially a small-diameter edge of the radial portion 42 towards the bearing 12. The radial portion 42 is located at one end of the outer and inner axial portions 38, 40. The opening 44 is axially located at the other end of the outer and inner axial portions 38, 40.

As a non-limiting example, the inner axial portion 40 of the sensor housing 34 comprises the rib 17 cooperating with the groove 29 located on the spacer 22 in order to secure the sensor device 16 onto the spacer 22. The sensor housing 34 defines an annular space 46 inside which is located the printed circuit board 36. The space 46 is radially delimited by the outer and inner axial portions 38, 40. The space 46 is axially delimited by the radial portion 42 and the opening 44. In the illustrated example, the sensor housing 34 also comprises a cable output 48 inside which is intended to engage a cable (not shown) for transmitting sensing data. The cable output 48 forms a protruding portion extending radially outwards from the outer surface of the sensor housing 34. The cable output 48 protrudes radially outwards from the outer axial portion 38 of the sensor housing 34.

In the depicted example, the cable output 48 has a tubular form. Alternatively, the cable output 48 may have any other appropriate shape, for example, a rectangular parallelepiped form. The cable engaged inside the cable output 48 comprises several electrical wires (not shown) connected to the printed circuit board 36.

In the disclosed example, the sensor device 16 is provided with the connecting cable for transmitting sensing data. Alternatively, the sensor device 16 may be formed without any such connecting cable in the case of wireless sensor elements. In this case, the sensor housing 34 does not include the cable output 48. For example, the sensor housing 34 is made of a synthetic material, such as PA 6.6 or PBT. Alternatively, the sensor housing 34 can also be made from other materials, such as for example, steel. The sensor housing 34 may be secured to the spacer 22 by any appropriate means, for example by overmolding, gluing, plastic welding, etc. The printed circuit board 36 is secured to the sensor housing 34. Preferably, the printed circuit board 36 is housed inside the space 46 defined within the sensor housing 34.

In the illustrated example, the inner surface of the outer axial portion 38 and the surface of the inner axial portion 40 have a stepped profile defining a shoulder 45. The printed circuit board 36 is secured to the shoulder 45 and axially faces the impulse ring 14 and the bearing 12. The printed circuit board 36 is axially mounted against the shoulder 45. Alternatively, the printed circuit board 36 may be secured to the inner axial portion 40 or to the outer axial portion 38 of the sensor housing 34.

The sensor elements 35 are supported by the printed circuit board 36 which is itself supported by the sensor housing 34. As will be described later, the sensor elements 35 are mounted on the printed circuit board 36 axially on the side of the opening 44 of the sensor housing 34. As previously mentioned, the impulse ring 14 is secured to the outer ring 18. The impulse ring 14 is secured onto the outer surface 20b of the outer ring. The impulse ring 14 is secured onto the second cylindrical portion 20b2. As will be described later, the outer diameter of the impulse ring 14 is smaller than the outer diameter of the outer ring 20. The impulse ring 14 radially surrounds the spacer 22. In the disclosed example, the impulse ring 14 is made in one part. The impulse ring 14 is made of metal.

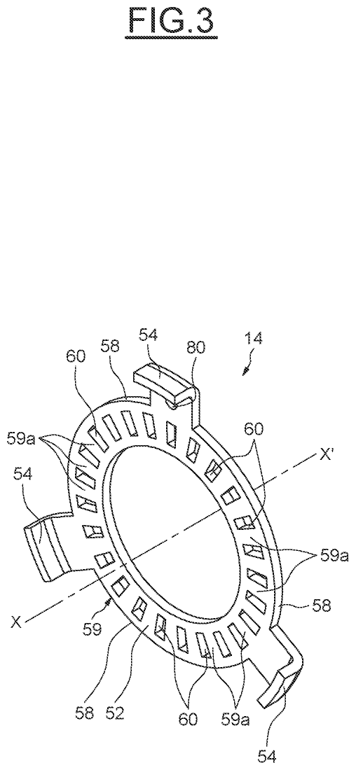

As shown on FIGS. 1 to 3, the impulse ring 14 comprises an annular radial portion 52, and a plurality of outer axial lugs 54 extending axially from the radial portion 52. Each lug 54 extends axially a large-diameter edge of the radial portion 52. The lugs 54 are spaced apart in the circumferential direction, here regularly. The lugs 54 are here identical one to another. However, in an alternative embodiment, the lugs may be different from each other. In the illustrated example, three lugs 54 are provided. Alternatively, a different number of lugs 54 may be foreseen, for example at least two lugs. For example, each lug 54 may extend over an angular sector comprised between 0° and 180°. As illustrated, each lug 54 extends over an angular sector equal to 45°. As a non-limiting example, each lug 54 extend over the same angular sector. However, the lugs may also extend over different angular sectors.

In the illustrated example, the portion 52 of the impulse ring bears axially on the lateral face 20c of the outer ring 20 of the bearing. The radial portion 52 of the impulse ring 14 axially faces the lateral face 20c and also comes into axial contact with the lateral face 20c. Alternatively, a slight axial gap may be provided between the impulse ring 14 and the lateral face 20c. The lugs 54 of the impulse ring 14 are secured radially on the second cylindrical portion 20b2 of the outer surface 20b of the outer ring. Each lug 54 radially comes into contact with the second cylindrical portion 20b2 of the outer surface 20b. Each lug 54 is radially offset inwards, towards the inner ring 18, with respect to the first cylindrical portion 20b1 of the outer surface of the outer ring. The impulse ring 14 is entirely radially offset inwards with respect to the first cylindrical portion 20b1. The outer surface of the lugs 54 defines the outer diameter of the impulse ring 14. The outer diameter of the impulse ring 14 is less than the outer diameter of the outer ring 20.

Alternatively, the outer diameter of the impulse ring 14 may be equal to the outer diameter of the outer ring 20. In this case, no lug may be provided on the impulse ring 14. For example, the lugs 54 of the impulse ring 14 are formed by bending the radial projections of the impulse ring so as to form an L-shape. As an alternative, each lug 54 could be provided with a hook extending radially inwards from an end of the lug 54, opposite to the radial portion 52, and engaging inside a groove formed on the outer surface of the outer ring 20 to axially retain the impulse ring 14 relative to the outer ring 20.

In the illustrated example, the impulse ring 14 is provided with a plurality of through-openings 58 formed on the radial portion 52. The openings 58 extend through the axial thickness of the radial portion 52. The openings 58 are spaced apart in the circumferential direction, preferably regularly or evenly spaced. The openings 58 are preferably identical to one to another. In the illustrated example, three openings 58 are provided. Alternatively, a different number of openings 58 may be foreseen, for example only one opening, or at least two openings 58. For example, each opening 58 may extend over an angular sector including between 0° and 180°. Alternatively, it is possible to foresee another angular size for the openings 58. As explained above, in another embodiment, the angular sectors of the openings 58 may be different.

In the illustrated example, each through-opening 58 is circumferentially disposed between two successive lugs 54 while being radially offset inwards. Each through-opening 58 opens radially outwards. With the through-openings 58, the radial portion 52 is provided at its periphery with radial sectors, in this example three radial sectors. Each through-opening 58 is formed on the radial portion 52 of such that a part of the first lateral face 20c of the outer ring 20 is accessible from the outside through the opening 58. In other words, each opening 58 of the radial portion 52 leaves free a part of the lateral face 20c of the outer ring. As will be described later, the through-openings 58 of the impulse ring 14 enables axially pushing directly on the outer ring 20 of the bearing 12 during the installation of the sensor bearing assembly 10.

Each through-opening 58 is formed on the radial portion 52 of the impulse ring 14 so as to be radially located between the bore 20a and the outer surface 20b of the outer ring 20. Each through-opening 58 is radially offset outwards with respect to the bore 20a and radially offset inwards with respect to the outer surface 20b. As a non-limiting example, the inner diameter of each through-opening 58 is, as illustrated, larger than the diameter of the bore 20a, and its outer diameter is smaller than the diameter the outer surface 20b. In this example, the body 59 of the radial portion 52 of the impulse ring 14 is also provided with a plurality of through slots or apertures 60 regularly spaced apart in the circumferential direction.

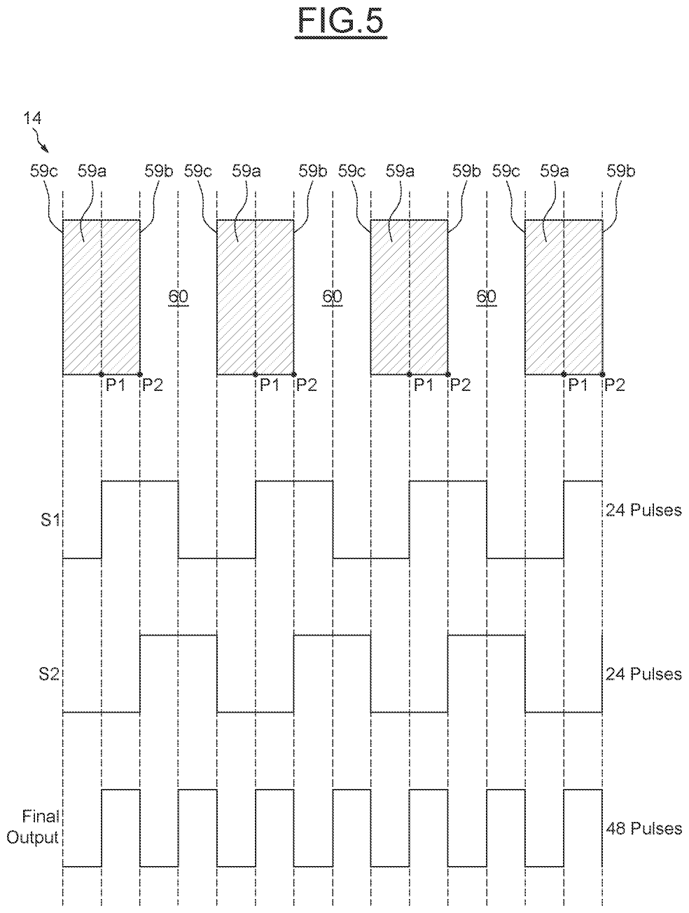

The apertures 60 extend through the axial thickness of the body 59 of the radial portion 52. The apertures 60 are radially offset inwards with regard to the through-openings 58. A solid part or tooth 59a is formed between each pair of successive apertures 60. Hence, the impulse ring 14 is provided with alternating solid parts/sections 59a and apertures 60 in the circumferential direction. As previously mentioned, each sensor element 35 is mounted on the printed circuit board 36 axially on the side of the opening 44 of the housing 34. As will be described in reference to FIG. 5, each sensor element 35 cooperates with the impulse ring 14 in order to sense multiple unique points on the impulse ring 14 and to deliver an output signal with each of the multiple unique points.

The sensor elements 35 are disposed on the same diameter on the printed circuit board 36. Each sensor element 35 is radially aligned with one of the solid parts 59a or apertures 60 of the impulse ring 14. The sensor elements 35 may be regularly or not spaced apart in the circumferential direction. Alternatively, a different number of sensor elements 35 may be foreseen, for example more than two sensor elements 35, for example three sensor elements 35 or at least four sensor elements 35. Preferably, the sensor elements 35 may comprise magnetic sensors, for example having a moving or a stationary magnet. For example, the impulse ring 14 may include alternating North and South poles and the sensor elements 35 may include Hall-effect sensors. In a general way, the impulse ring 14 and the sensor elements 35 may use any other suitable technology, for example, induction technology, optical technology, or any other sensing technologies.

In the illustrated example, the sensor bearing assembly 10 further comprises a seal 64 mounted on the outer surface of the sensor housing 34. The seal 64 is mounted on the outer surface of the outer axial portion 38 of the sensor housing 34. The seal 64 has an annular form. In the depicted embodiment, the seal 64 is mounted in a groove 47 provided on the outer surface of the outer portion 38 of the sensor housing 34. The seal 64 is provided with an annular heel 64a and with an annular friction lip 64b projecting from the heel 64a. The friction lip 64b extends outwardly from the heel 64a. The friction lip 64b extends obliquely on the side opposite to the bearing 12. The lip 64b is flexible in the radial direction. In the illustrated example, the seal 64 is provided with only one lip 64b. Alternatively, the seal 64 may be provided with two lips or with three or more lips. The seal 64 may be made of elastomeric material, for example polyurethane. The seal 64 is secured to the sensor housing 34 by any appropriate means, for example by gluing, by overmolding, etc.

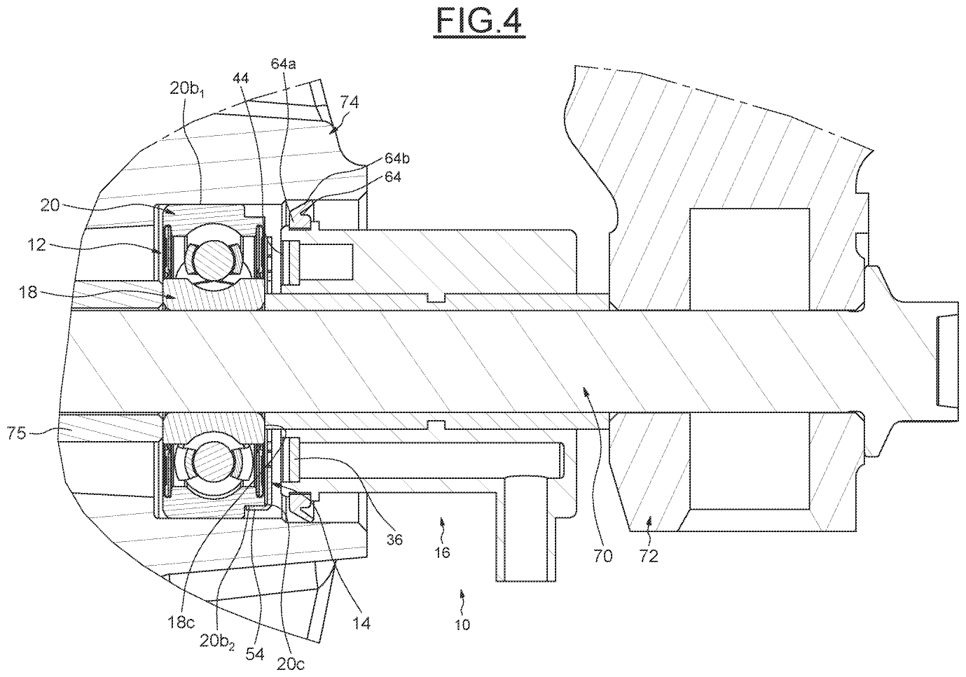

As previously mentioned, the sensor bearing assembly 10 is particularly adapted to equip a vehicle. As shown partially on FIG. 4, the sensor bearing assembly 10 is mounted on a shaft 70 of a wheel between one arm 72 of a fork and a wheel spacer 75 and surrounded partially by the wheel hub 74. The sensor bearing assembly 10 is mounted into a bore of the wheel hub 74. The bearing 12 of the sensor bearing assembly is mounted into the bore of the wheel hub 74. The sensor housing 34 and the spacer 22 are partly located inside the wheel hub 74 and protrude axially outwards. The inner ring 18 of the bearing 12 is mounted on the shaft 70 of the wheel and bears axially against the wheel spacer 75. The outer ring 20 is mounted into the bore of the wheel hub 74. The outer ring 20 is intended to rotate with the wheel hub 74 while the inner ring 18 is intended to be fixed.

Since the outer diameter of the impulse ring 14 is smaller than the outer diameter of the outer ring 20, there is no contact between the impulse ring 14 and the wheel hub 74. Similarly, since the outer diameter of the sensor housing 34 is smaller than the outer diameter of the outer ring 20, there is no contact between the sensor housing 34 and the wheel hub 74. In order to mount the bearing 12 inside the wheel hub 74, a specific mounting tool (not shown) may be used. The mounting tool may be provided with three axial teeth spaced apart in the circumferential direction and configured to be engaged into one of the through-openings of the impulse ring 14 without contact with the impulse ring 14.

For example, each tooth of the mounting tool extends through one of the openings of the impulse ring 14 and axially come into contact with the lateral face 20c of the outer ring 20 of the bearing 12. The through-openings of the impulse ring 14 allow the passage of the teeth of the tool to axially abut directly on the lateral face 20c of the outer ring 20. The axial contact between the teeth of the tool and the lateral face 20c of the outer ring 20 is the only contact between the tool and the sensor bearing assembly 10. An axial force is exerted directly onto the lateral face 20c of the outer ring 20 with the aid of the tool in order to mount the bearing into the wheel hub 74. Preferably, the outer ring 20 is press-fitted into the wheel hub 74. The through-openings of the impulse ring 14 enable to axially push directly on the outer ring 20 of the bearing 12 during the installation of the sensor bearing assembly 10 into the wheel hub 74. As an alternative and as illustrated, the body 59a of the radial portion 52 of the impulse ring 14 comprise a guide through-hole 80 extending through the axial thickness of the radial portion 52. The guide through-hole 80 is preferably used for mounting the assembly 10 formed by the impulse ring 14 and the bearing 12 on the wheel hub 74 without any contact on the surface of the impulse ring 14.

The shaft 70 is mounted inside the bore of the inner ring 18 of the bearing 12 and the bore of the spacer 22. The spacer 22 axially abuts against the lateral face 18c of the inner ring 18 at one end, and axially abuts against one of the arms 72 of the fork at the opposite end. The lip 64a of the seal 64 bears against the bore of the wheel hub 74. The lips 64b of the seal 64 prevent the exterior pollutants from flowing toward and contacting the impulse ring 14. As previously mentioned, in the first illustrated example, the impulse ring 14 is secured to the outer ring 20 of the bearing 12 by press-fitting or gluing the axial lugs 54 onto the second cylindrical portion 20b2 of the outer ring 20. Alternatively, it is possible to directly secure the impulse ring 14 to the outer ring 20 of the bearing 12 by other means, for example, by riveting over the lateral face 20c of the outer ring 20 or by using dowel pins. In such case, the impulse ring 14 may be formed without lugs and may include through-holes (not shown) formed on the radial portion 52 of the impulse ring 14. The holes extend through the axial thickness of the radial portion 52. The rivets or the dowel pins (not shown) extend through the holes of the impulse ring 14 and into blind holes formed on the lateral face 20c of the outer ring 20 in order to secure the impulse ring 14 to the outer ring 20.

In another example, the impulse ring 14 may be secured to the first lateral face 20c of the outer ring 20 by gluing. With such an impulse ring 14, it is not necessary to provide a stepped shape for the outer surface of the outer ring 20 of the bearing 12. In the illustrated examples, the sensor bearing assembly 10 is provided with a rolling bearing 12 comprising one row of rolling elements 23. Alternatively, the rolling bearing 12 may include at least two rows of rolling elements 23. In the illustrated examples, the rolling elements 23 are balls. Alternatively, the rolling bearing 12 may include other types of rolling elements, for example rollers. In another variant, the rolling bearing 12 may also be formed as a sliding bearing or plain bearing having no rolling elements. As explained above, in case of magnetic technology, the impulse ring 14 may include alternating North and South poles and the sensor elements 35 may include magnetic sensors.

The processing of the output signals of the sensor elements will be described referring to FIG. 5. In the example shown in FIG. 5, the sensor device 16 includes two sensor elements 35 mounted on the printed circuit board 36. The two sensor elements 35 are each configured to sense unique multiple points P1, P2 on the impulse ring 14, notably on the solid part/section 59a, and to transmit an output signal S1, S2 having a unique set of points. As illustrated, the first sensor element 35 is mounted in order to sense the center of the solid part 59a of the impulse ring 14 and the second sensor element 35 is mounted in order to sense the trailing edge 59b of the impulse ring 14. As an alternative, the first sensor element 35 may be mounted in order to sense the leading edge 59c of the impulse ring 14 and the second sensor element 35 may be mounted in order to sense the trailing edge 59b of the impulse ring 14.

When the sensor device 16 includes three sensor elements 35, the center 59a, the leading edge 59c and the trailing edge 59b of the impulse ring 14 can be sensed. As a non-limiting example, the two sensor elements 35 are located at specific positions allowing to generate two 90° phase two shift pulses. For example, the two sensor elements 35 may be angularly spaced apart from each other at an angle of 94°. These two outputs signals S1, S2 are then processed through a high-speed logic circuit (not shown) to obtain a number of pulses as a resultant of phase shift, as will be described below. When the inner ring 18 of the bearing 12 rotates, the impulse ring 14 moves past the stationary sensor elements, generating a magnetic field of changing polarity. Each of the two sensor elements 35 outputs a pulse, the frequency of which depends on the number of polarities per second. The two output signals S1, S2, which are offset in phase, are transmitted to an electronic unit 90 via the sensor connecting cable, or via wireless means.

The electronic unit 90 is configured to process the two output signals S1, S2 into one final output signal. The two distinct output signals S1, S2 having each their unique set of points P1, P2 are thus merged into one single final output signal, thereby doubling the number of pulses per rotation as compared to the number of slots 60. The electronic unit 90 comprises a digital logic gate known as exclusive OR, “XOR”, receiving the two square waveforms output signals from the two sensor elements. The final output signal has the form of a square wave with twice the frequency. As illustrated, the number of pulses of each output signals S1, S2 transmitted from each sensor elements 35 is equal to the number of apertures 60 of the impulse ring 14 and the number of pulses of the final output signal is equal to the sum of the number of pulses of each output signals. For example, in an impulse ring 14 having twenty-four slots 60, and in case of the sensor bearing 10 including two sensor elements 35 each configured to sense twenty-four unique points on the impulse ring 14, the number of pulses of each output signals transmitted from each sensor element 35 is equal to twenty-four and the number of pulses of the final output signal is equal to forty-eight.

Therefore, it no longer necessary to increase the reading diameter or sensing diameter of the impulse ring 14 in case of higher number of pulses of the final output signal is needed. For example, in an impulse ring 14 having sixteen slots 60, and in case of the sensor bearing 10 comprises three sensor elements 35 each configured to sense sixteen unique points on the impulse ring 14, the number of pulses of each output signals transmitted from each sensor element 35 is equal to sixteen and the number of pulses of the final output signal is equal to forty-eight. In this case, the number of slots 60 is reduced, as well as the reading diameter of the impulse ring 14. In case a final of output signal of seventy-two pulses is needed with an impulse ring 12 of twenty-four slots 60, the sensor device 16 may comprise three sensor elements 35 each sensing twenty-four unique points on the impulse ring 14.

The processing of the output signals has been described in reference to two sensor elements 35. Alternatively, a different number of sensor elements may be foreseen, for example at least three or four sensor elements 35. The number of pulses of the final output signal is proportionately dependent on the number of sensor elements.

As well as a different number of slots 60 of the impulse ring 14. It is thus possible to increase the number of pulses per rotation of the final output signal without increasing the reading diameter of the impulse ring 14. The sensor bearing assembly 10 is thus easily implemented in any vehicle without modifying the surrounding components.

Representative, non-limiting examples of the present invention were described above in detail with reference to the attached drawings. This detailed description is merely intended to teach a person of skill in the art further details for practicing preferred aspects of the present teachings and is not intended to limit the scope of the invention.

Moreover, combinations of features and steps disclosed in the above detailed description may not be necessary to practice the invention in the broadest sense, and are instead taught merely to particularly describe representative examples of the invention. Furthermore, various features of the above-described representative examples, as well as the various independent and dependent claims below, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter. The invention is not restricted to the above-described embodiments, and may be varied within the scope of the following claims.

I claim:

1. A sensor bearing assembly comprising:
a bearing including an inner ring and an outer ring each centered on an axis;
an impulse ring secured to the outer ring of the bearing and having an outer diameter with a value less than or equal to a value of the outer diameter of the outer ring;
a sensor device for detecting rotational parameters of the impulse ring including a sensor housing, a printed circuit board secured to the sensor housing, and at least two sensor elements supported by the printed circuit board and cooperating with the impulse ring, each one of the at least two sensor elements being configured to sense unique multiple points on the impulse ring and to transmit an output signal having a unique set of points;
an annular spacer configured to axially abut against a lateral face of the inner ring of the bearing, the sensor housing of the sensor device being fixedly secured onto the spacer; and
an electronic unit configured to receive the output signal of the multiple points from each one of the at least two sensor elements and configured to merge the at least two output signals into one final output signal.

2. The sensor bearing assembly according to claim 1, wherein the electronic unit comprises a digital logic gate exclusive OR, receiving the at least two waveforms output signals from the at least two sensor elements and transmitting a final output signal having the form of a wave with at least twice the frequency.

3. The sensor bearing assembly according to claim 1, wherein the impulse ring includes alternating North and South poles and the sensor elements include magnetic sensors.

4. The sensor bearing assembly according to claim 1, wherein the impulse ring includes a plurality of alternating solid parts and through slots in the circumferential direction, each one of the at least two sensor elements being configured to sense one unique point on each one of the solid parts.

5. The sensor bearing assembly according to claim 4, wherein the number of pulses of each output signal transmitted from each one of the sensor elements is equal to the number of slots and the number of pulses of the final output signal is equal to the sum of the number of pulses of the output signals from the sensor elements.

6. The sensor bearing assembly according to claim 4, wherein one of the at least two sensor elements is configured to sense one unique point on each one of the solid parts of the impulse ring and the other of the at least two sensor elements is configured to sense another unique point on each one of the solid parts of the impulse ring.

7. The sensor bearing assembly according to claim 1, wherein the at least two sensor elements are angularly spaced apart from each other at an angle allowing the generation of two 90° phase two shift pulses.

8. The sensor bearing assembly according to claim 1, wherein the impulse ring includes a radial portion facing a lateral face of the outer ring of the bearing, and at least one opening extending through the thickness of the radial portion such that a part of the lateral face of the outer ring of the bearing is accessible from the outside through the opening.

9. The sensor bearing assembly according to claim 1, wherein the impulse ring includes a plurality of axial lugs spaced apart in the circumferential direction, one opening being circumferentially disposed between two successive axial lugs of the impulse ring.

10. The sensor bearing assembly according to claim 1, wherein the outer surface of the outer ring of the bearing includes a shoulder axially delimiting a first cylindrical portion and a second cylindrical portion of the outer surface, the axial lugs of the impulse ring being secured directly to the second cylindrical portion.
